(19) United States
(12) Patent Application Publication
(10) Pub. No.: US 2020/0108653 A1
(43) Pub. Date: Apr. 9, 2020

(54) METHODS AND SYSTEMS OF MULTI-FUNCTIONAL WRITING DEVICE

(71) Applicants: HEMAL B. KURANI, SUNNYVALE, CA (US); HETAL B. KURANI, SUNNYVALE, CA (US)

(72) Inventors: HEMAL B. KURANI, SUNNYVALE, CA (US); HETAL B. KURANI, SUNNYVALE, CA (US)

(21) Appl. No.: 16/385,473

(22) Filed: Apr. 16, 2019

Related U.S. Application Data
(63) Continuation-in-part of application No. 15/897,157, filed on Feb. 15, 2018, now abandoned.

(51) Int. Cl. B43K 29/10; B43K 27/02; B43K 29/00; B43K 29/02; B43K 29/08

(52) U.S. Cl. CPC B43K 29/10; B43K 27/02; B43K 29/08; B43K 29/02; B43K 29/001

(57) ABSTRACT

A multifunctional writing instrument includes a hollow body, wherein the hollow body comprises one or more cavities configured to attach with a projector pen and projector stick to project plurality of technical drawing tools images. A first writing member having a first writing tip is included. The first writing member includes lead and a mechanical pencil system being provided in a first portion of the hollow body, and wherein the first writing tip is axial with respect to the hollow body. A second writing member having a second writing tip is included. The second writing member comprises ink and an ink pen system being provided in a second portion of the hollow body. The first portion of the hollow body is at an opposite end of the second portion of the hollow body. The second writing tip is axial with respect to the hollow body.

### CLAIM OF PRIORITY

This application is a child application of utility patent METHODS AND SYSTEMS OF MULTI-FUNCTIONAL WRITING DEVICE, U.S. patent application Ser. No. 15/897,157 and filed on Feb. 15, 2018.

### FIELD OF THE INVENTION

This application relates generally writing instruments, and more specifically to a system, article of manufacture, projecting of images and method of multi-functional writing device.

### DESCRIPTION OF THE RELATED ART

Today, almost all people have a pen or pencil with them, because they are so light and easy to carry around. People have also found all sorts of ways to make them look diverse and have added so many new functions to them in our contemporary society. People have also used styluses, pencils, geometry tools like compasses, rulers, protractors, set squares and other fancy stationary supplies, but they have to carry and use multiple devices.

In stores these days, most of the products in this device are sold individually or in some combination based on prior art solution at exorbitant prices. Further problem is compounded where there does not exist drawing tools such as, for example: a ruler, a compass, a protractor and a set squares in a single device. The problem exists where person has to purchase, carry and use multiple devices. However, this device combines all of them in a single housing and makes it easily affordable. School kids won't have to lug a whole box of pens, pencils and drawing sets to school; instead, they will be able to transport all of the most critical writing and drawing tools in only one device.

Teachers, architects, engineers, builders, construction worker, doctors, scientists, astronomers, cosmonauts, police, firefighters, etc. will not have to carry multiple devices. They won't have to buy all the devices at expensive prices; instead they will only need this device comprising all the input writing and drawing sets at the reasonable price. The benefits are many for e.g. The device consisting of all commonly used tools will help students who can't afford individual school supplies at high cost, reduce the school class room supplies cost, person has to carry single device instead of multiple items thereby reducing the space and worrying about breaking or losing individual items, reduce waste since the device is reusable and environmentally friendly. The technical drawing tools are usually made of plastic. The present invention also eliminates the plastic waste because the technical drawing tools are now projected images. Thus, there remains a considerable need for a device that is lighter, portable and does not break and can conveniently house in a single housing a ball point pen, mechanical pencil, stylus pen for touch screen, eraser, compass, projector pen and projector stick to project ruler, protractor, set square of forty-five-degree (45°) triangle, set square thirty/sixty-degree (30/60°), and a grip.

### SUMMARY OF THE INVENTION

In one aspect, a multifunctional writing instrument includes a hollow body, wherein the hollow body comprises one or more cavities configured to attach with a projector pen and a projector stick to project plurality of technical drawing tools images visible on paper, screen or any surface. A first writing member having a first writing tip is included. The first writing member includes lead and a mechanical pencil system being provided in a first portion of the hollow body, and wherein the first writing tip is axial with respect to the hollow body. A second writing member having a second writing tip is included. The second writing member comprises ink and an ink pen system being provided in a second portion of the hollow body. The first portion of the hollow body is at an opposite end of the second portion of the hollow body. The second writing tip is axial with respect to the hollow body.

### BRIEF DESCRIPTION OF THE DRAWINGS

FIG. 1 illustrates an example schematic view of a multi-functional writing device, according to some embodiments.

FIG. 2 illustrates another example side view of a multi-functional writing device, according to some embodiments.

FIG. 3 illustrates an example perspective view of a multi-functional writing device, according to some embodiments.

FIG. 4 illustrates another example side view of a multi-functional writing device, according to some embodiments.

FIG. 5 illustrates another example side view of a multi-functional writing device, according to some embodiments.

FIG. 6 illustrates another example side view of a multi-functional writing device showing a USB port, according to some embodiments.

FIG. 7 is another front perspective view with top and bottom part of the multi-functional writing device of the present invention. It also has top and front view of the device stand, and top and front view of the device holder.

FIG. 8 is side view with a projector pen, projecting the ruler of the multifunctional writing device out of the present invention, bottom view projecting the ruler.

FIG. 9 is side view with a projector pen, projecting the protractor out of the multifunctional writing device of the present invention, bottom view projecting the protractor.

FIG. 10 is side view with a projector pen, projecting the set square forty-five-degree (45°) triangle out of the multifunctional writing device of the present invention, bottom view projecting the set square forty-five-degree (45°) triangle.

FIG. 11 is side view with a projector pen, projecting the set thirty/sixty-degree (30/60°) triangle out of the multifunctional writing device of the present invention, bottom view projecting the thirty/sixty-degree (30/60°) triangle.

FIG. 12 is side view with a projector pen, projecting any object of the multifunctional writing device out of the present invention, bottom view projecting any object.

FIG. 13 is side view with a projector pen, projecting concentrated light point or dot out of the multifunctional writing device of the present invention, bottom view projecting the concentrated light point or dot.

FIG. 14 is side view with a projector stick, projecting the ruler out of the multifunctional writing device of the present invention, top view projecting the ruler.

FIG. 15 is side view with a projector stick, projecting the protractor out of the multifunctional writing device of the present invention, top view projecting the protractor.

FIG. 16 is side view with a projector stick, projecting the set square forty-five-degree (45°) triangle out of the multifunctional writing device of the present invention, top view projecting the set square forty-five-degree (45°) triangle.

FIG. 17 is side view with a projector stick, projecting the set thirty/sixty-degree (30/60°) triangle out of the multifunctional writing device of the present invention, top view projecting the set thirty/sixty-degree (30/60°) triangle.

FIG. 18 is side view with a projector stick, projecting any object of the multifunctional writing device out of the present invention, top view projecting any object of the multifunctional writing device.

FIG. 19 is side view with a projector stick, projecting concentrated light point or dot of the multifunctional writing device out of the present invention, top view projecting the concentrated light point or dot.

FIG. 20 is a diagram of an exemplary sample multi-functional writing device LED projector components, microcomputer and sensors arrangement that can be utilized to implement various embodiments.

The Figures described above are a representative set and are not an exhaustive with respect to embodying the invention.

### DESCRIPTION

Disclosed are a system, method, and article of manufacture for methods and systems of multi-functional writing device. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Exemplary Definitions

Application programming interface (API) can specify how software components of various systems interact with each other. The API can also be used to create mobile app to interact with multifunction writing device.

BLUETOOTH is a wireless technology standard for exchanging data over short distances (e.g. using short-wavelength UHF radio waves in the ISM band from 2.4 to 2.485 GHz[4]) from fixed and mobile devices, and building personal area networks (PANs), etc. It is noted that other communication systems that transmit signals with messages from user's device to recipients can be used as well.

Cloud computing can involve deploying groups of remote servers and/or software networks that allow centralized data storage and online access to computer services or resources. These groups of remote serves and/or software networks can be a collection of remote computing services.

Compass can be a drawing tool used to inscribe circles, arcs, etc. A compass can be a piece of equipment used for drawing circles, consisting of two thin parts joined in the shape of the letter V A piece of equipment used for measuring or drawing lines and angles, consisting of two pieces of metal or other materials with pointed ends that are joined together at the top. The compass is a technical drawing instrument that can be used for inscribing circles and/or arcs. As dividers, they can also be used as tools to measure distances, in particular on maps. Compasses can be used for mathematics, drafting, navigation, and other purposes.

Haptic technology can interface with the user through the sense of touch.

Digital laser light level is a digital way to indicate whether a surface is horizontal (level) or vertical (plumb).

Digital micromirror device (DMD) is an optical semiconductor (e.g. a micro-opto-electromechanical system (MOEMS)) in a digital light projection (DLP) system.

Projector pen and a projector stick are optical device that projects an image or video onto a surface.

Mobile device can include a handheld computing device that includes an operating system (OS), and can run various types of application software, known as apps. Example handheld devices can also be equipped with various context sensors (e.g. biosensors, physical environmental sensors, etc.), digital cameras, Wi-Fi, Bluetooth, and/or GPS capabilities. Mobile devices can allow connections to the Internet and/or other Bluetooth-capable devices, such as, inter alia: an automobile, a wearable computing system and/or a microphone headset. Exemplary mobile devices can include smart phones, tablet computers, optical head-mounted display (OHMD) (e.g. Google Glass®), virtual reality head-mounted display, smart watches, other wearable computing systems, etc.

Pen can be a writing implement used to apply ink to a surface, such as, inter alia: paper, for writing or drawing.

Pencil can be a writing implement or art medium constructed of a narrow, solid pigment core inside a protective casing which prevents the core from being broken or leaving marks on the user's hand during use.

Protractor can be a measuring instrument projected through the projector stick or pen, for measuring angles. A protractor can measure angles in degrees (°). A radian-scale protractors measure angles in radians. A protractor can be divided into one-hundred and eighty (180) equal parts.

Wireless power transfer (WPT) is the transmission of electrical energy without wires. Wireless power transmission technologies can use time-varying electric, magnetic, or electromagnetic fields.

Stylus can be a writing utensil, or a small tool for some other form of marking or shaping. a small pen-shaped instrument that is used to input commands to a computer screen, mobile device or graphics tablet. With touchscreen devices, a user can place a stylus on the surface of the screen to draw or make selections by tapping the stylus on the screen. A stylus tip can be a nib.

Technical drawing tool can be pen, pencil, compass, protractor, compass needle, ruler, protractor, set square forty-five-degree (45°) triangle, set square thirty/sixty-degree (30/60°) triangle, ellipsograph, a T-square, a opisometers and so on.

Universal Serial Bus (USB) is an industry standard that defines cables, connectors and communications protocols for connection, communication, and power supply between computers and devices.

Exemplary Systems and Methods

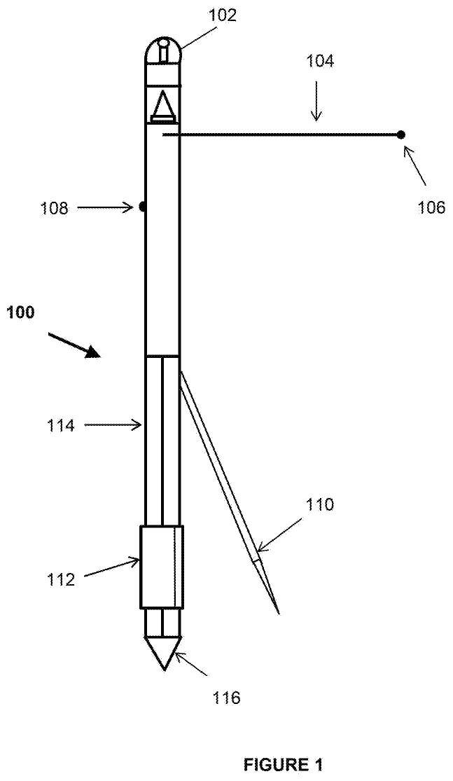

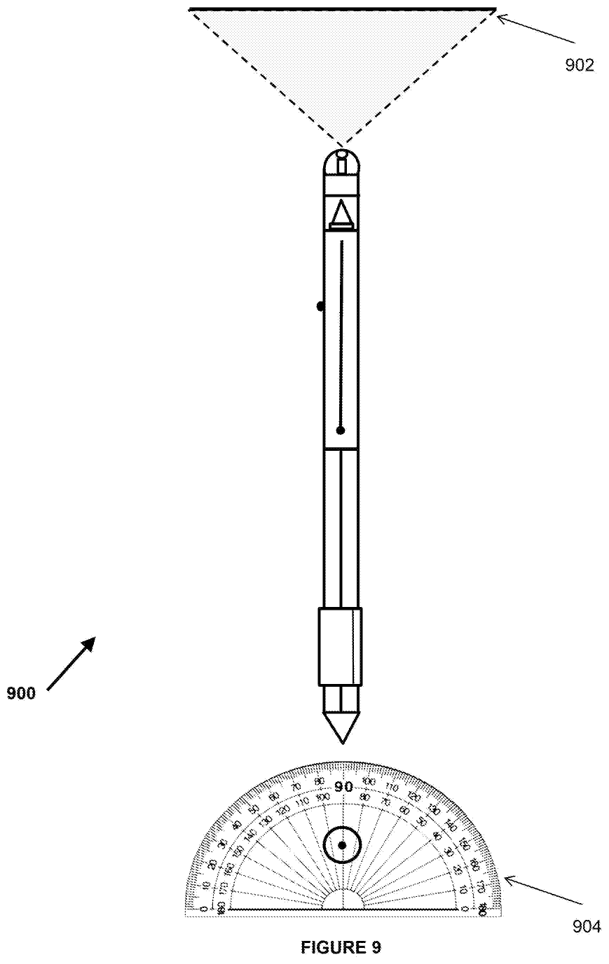

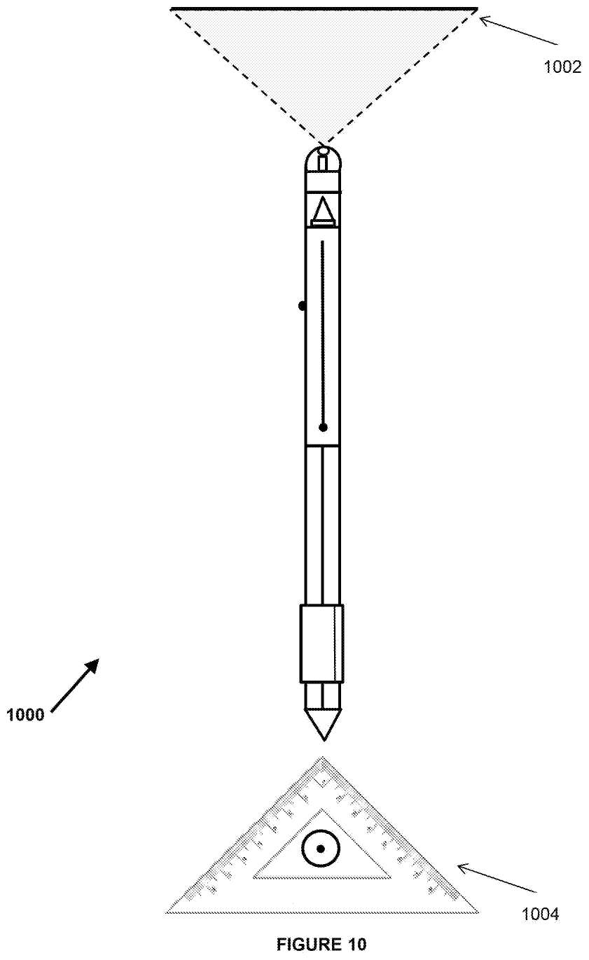

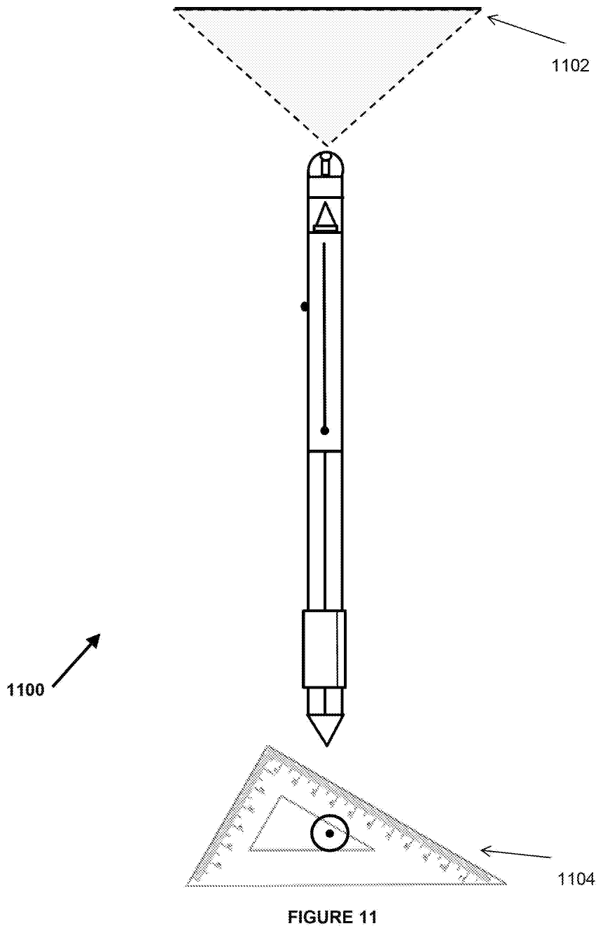

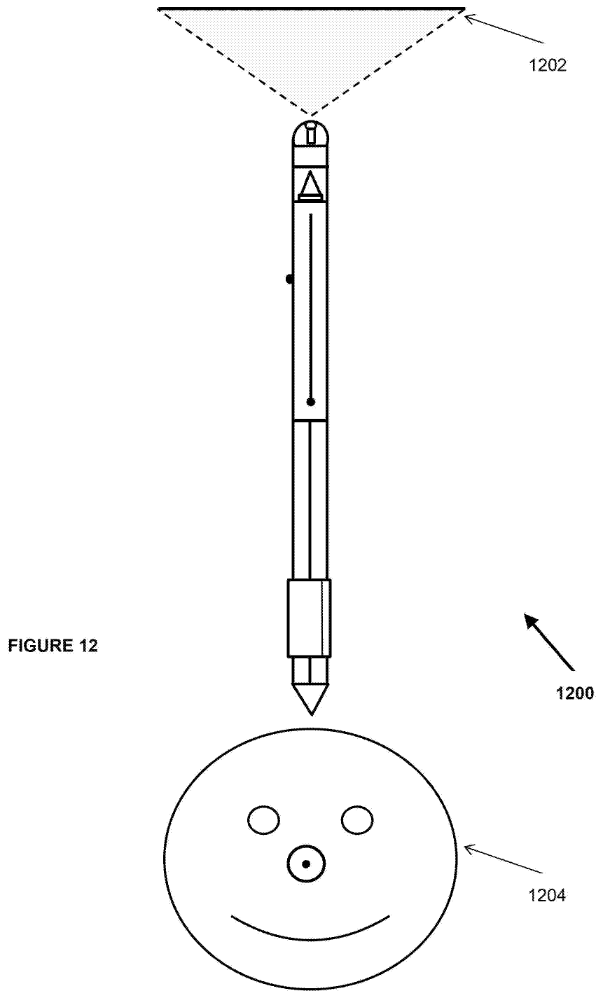

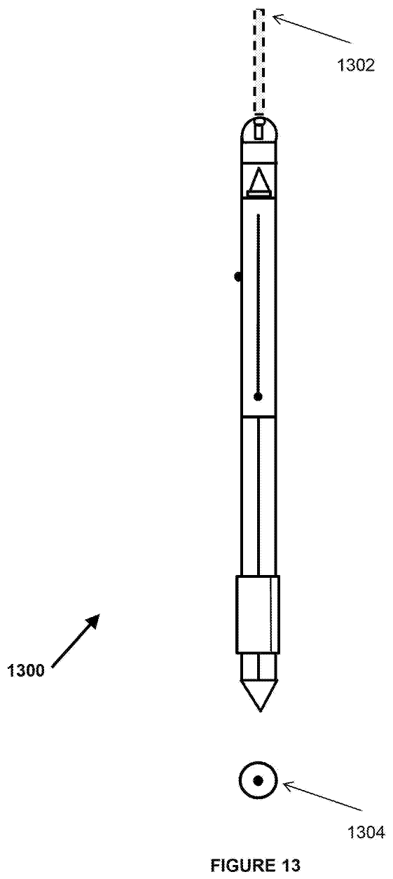

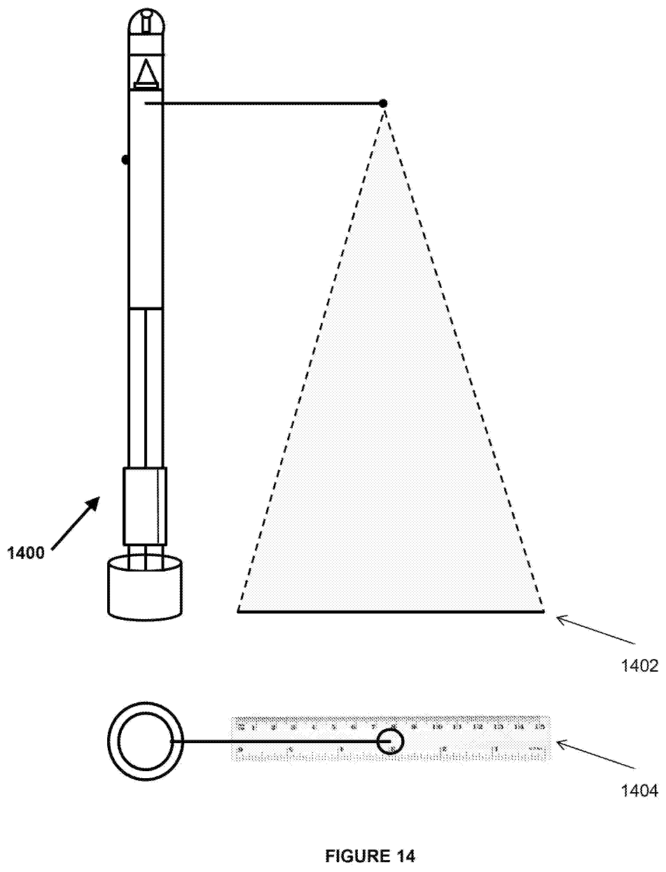

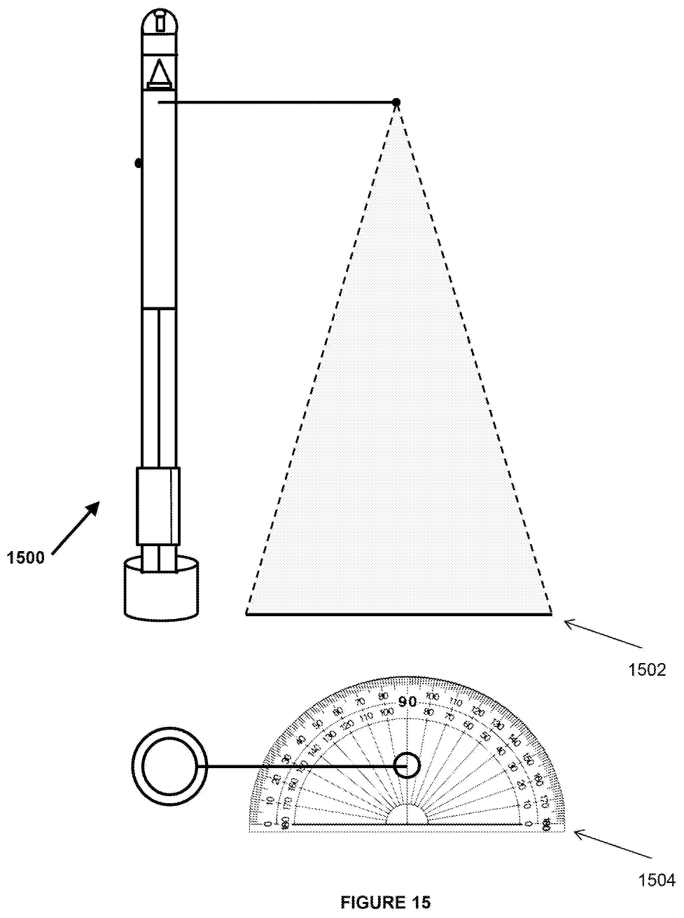

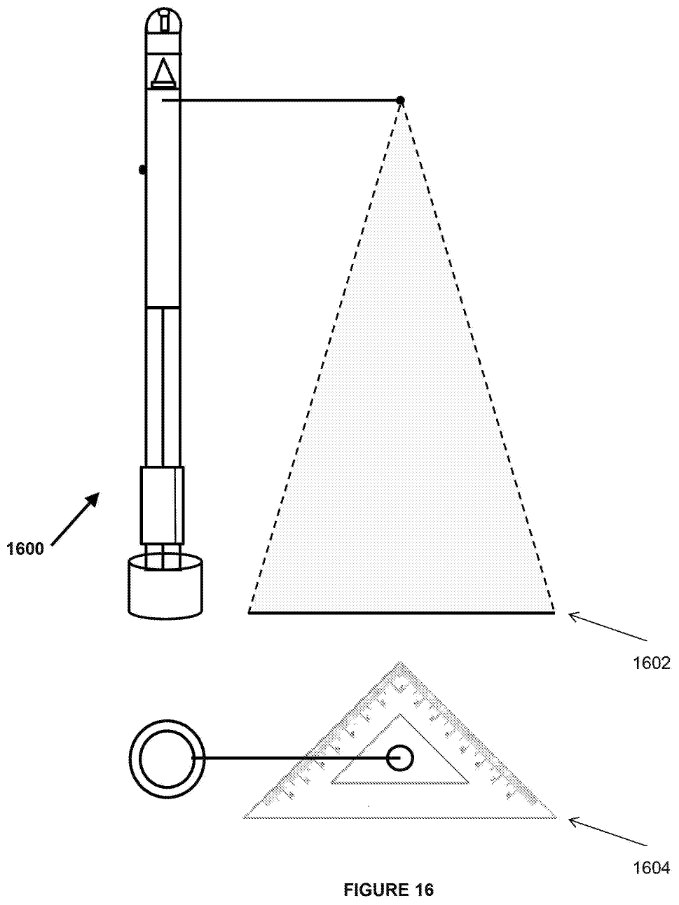

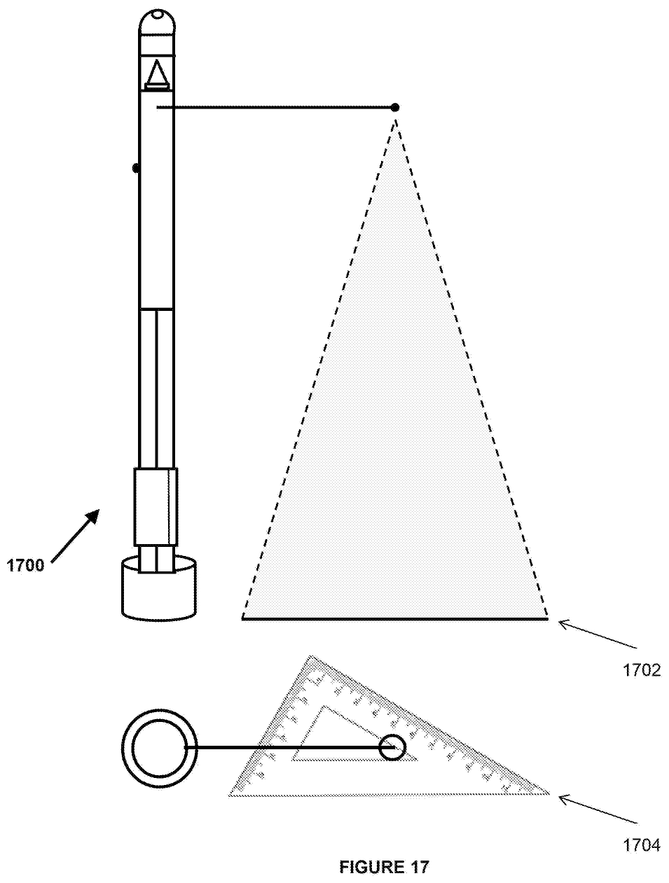

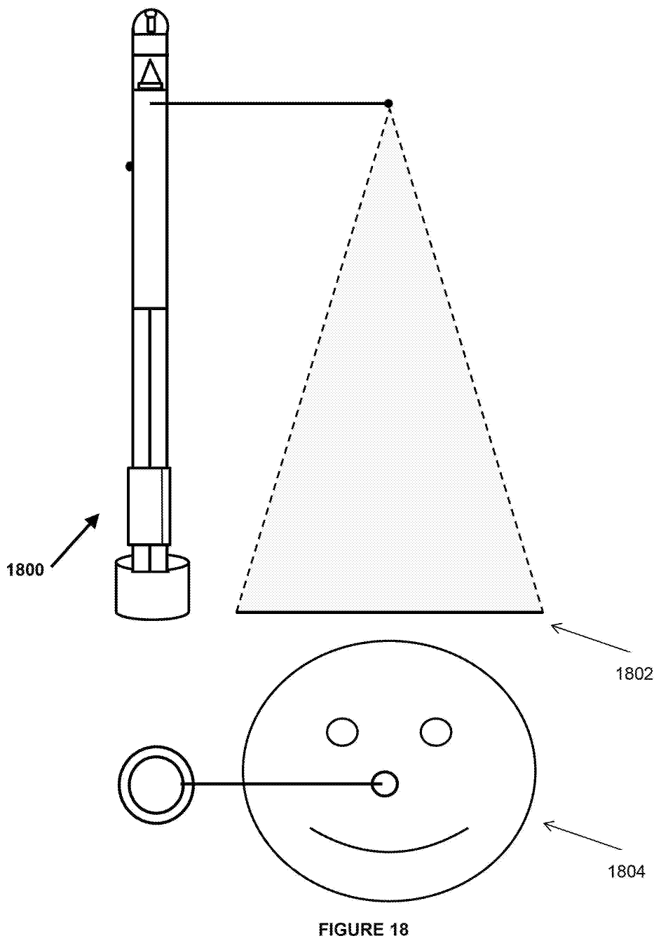

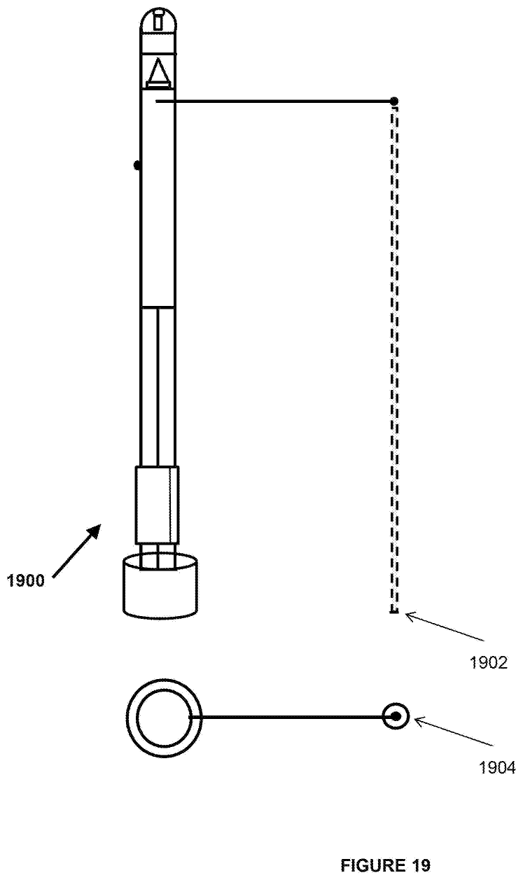

FIGS. 1-20 illustrate various perspectives and views of an example multi-functional writing device 100. Multi-functional writing device 100 can include various other integrated devices, including, inter alia: a pen, pencil, stylus pen for touch screen input device for writing, and projected images of geometry tool kit. It consists of a projector pen 102, a projector stick 104 and lens 106, an on/off projector button 108, a compass needle 110 contained in a single housing and/or any various permutations thereof. Projector stick 104 can be flexible tube and the logic of the intensity and focus can be adjusted. It is noted that in some example embodiments, the multifunctional writing device 100 can include various projected images of technical drawing tools including and are not limited to: rulers, protractors and drawing utilities (e.g. modified T-squares, French curves, templates, perspective machines, curved rulers, etc.). Drafting tools can be used for measurement and layout of drawings, or to improve the consistency and speed of creation of standard drawing elements. The multifunctional writing device 100 cavities can include a projector pen 102 and projector stick 104 to project a plurality of technical drawing tools shape(s). The multifunctional writing device 100 can include storage cavities for storing ink, pencil leads, eraser(s), etc. In one example, multi-functional writing device 100 can include a ball point pen, mechanical pencil, stylus pen for touch screen, eraser, compass needle 110, projected ruler image 804 and 1404, projected protractor image 902 and 1504, projected image of the square forty-five-degree (45°) triangle 1004 and 1604, projected image of set square thirty/sixty-degree (30/60°) triangle 1104 and 1704, projected image of any shape 1204 and 1804 (in this case a smiley is shown), projected image of a point or dot 1304 and 1904, and a grip 112.

In one example embodiments, the multifunctional writing device 100 can enable a user to use it for many purposes with a single writing system. The multifunctional writing device 100 can include a mechanical pencil and ball pen projecting out from either side to make transfer from pen to pencil easier with only a flip of the device. The multifunctional writing device 100 can have a stylus pen. The stylus pen can enable writing and drawing in active touch screen. The multifunctional writing device 100 can include an eraser sticking out from the cap of the pen and a customizable grip on the pencil to make the appearance fashionable while still being comfortable. A compass needle 110, a projector pen 102, and a projector stick 104 containing lens 106 is also coupled with the body of the multifunctional writing device 100.

A multifunctional writing device 100 can include various light projected mathematical instruments images. Mathematical instruments can be a tool or device used in the study or practice of mathematics. Example mathematical instruments can include: rulers, dividers, protractors, set squares, compasses, ellipsographs, T-squares and/or opisometers.

The multifunctional writing device 100 can include laser pen. As used herein, a laser pen can be a small handheld device with a power source (e.g. a battery) and a laser diode emitting a very narrow coherent low-powered laser beam of visible light, intended to be used to highlight something of interest by illuminating it with a small bright spot of colored light. The laser light is also used to indicate whether the technical drawing tool image is horizontal (level) or vertical (plumb).

The multifunctional writing device 100 can include a digital pen. A digital pen can be an input device which captures the handwriting or brush strokes of a user. The digital pen can convert handwritten analog information into digital data. The digital data can enable the data to be utilized in various applications. For example, the writing data can be digitized and uploaded to a computer and displayed on its monitor. The data can then be interpreted by handwriting software (OCR) to allow the digital pen to act as a text entry interface and be used in different applications or just as graphics. Computing systems provided infra can utilize said digital data for various other applications. In some embodiments, integrated devices 102 can include digital input sensors for obtaining additional digital data. A digital pen can include various sensors for obtaining position and/or motion Information, including, Inter alia: an accelerometer, gyroscopes, etc. In one example, a digital pen can be an accelerometer-based digital pen contain components that detect movement of the pen and contact with the writing surface. In another example, a digital pen can include electronic components whose signals are picked up by a mobile device's built-in digitizer and transmitted to its controller, providing data on pen location, pressure, button presses and other functionalities. In another example, a digital pen can be a position-based digital pen that uses a facility to detect the location of the tip during writing. In another example, a digital pen can be camera-based pens use special digital paper to detect where the stylus contacts the writing surface. In another example, a digital camera can be a trackball pen, using a sensor located on the pen to detect the motion of the trackball. In another example, the hand drawings are directly converted into three-dimension (3D) illustrations.

The multifunctional writing device 100 can include mechanisms for coupling compass needle, a projector pen, and a projector stick with said multifunctional writing device. The multifunctional writing device 100 can include devices for projecting images. The project pen and project stick eliminates need for mechanical technical drawing took kits. This makes the multi-functional writing device very light weight. The multifunctional writing device 100 can include light sources and/or light bulbs (e.g. light-emitting diodes, etc.). The multifunctional writing device 100 can include various sensors (e.g. chemical sensors, positional sensors, electro-magnetic sensors, antennas, microphones, etc.). The multifunctional writing device 100 can include a LED, projector circuits, digital camera, wireless systems, Bluetooth® systems, RFID systems, computer processors, user-input systems, speakers, etc.

The multifunctional writing device 100 can benefit various user types, such as, inter alia: students, teachers, architects, engineers, builders, construction worker, doctors, scientists, astronomers, cosmonauts, police, firefighters, etc. User can be more organized with one device for multiple uses instead of multiple devices for one use. Some advantages of the multifunctional writing device 100 can various applicable situations such as, inter alia: writing and drawing. For example, when students perform assignments like homework, exercises, tests, the multifunctional writing device can execute tasks such as, for example: auto grading their assignments and storing/sending the data to the teacher/school network servers. The multifunctional writing device 100 can be lightweight and composed of various materials like plastic, wood, carbon fiber, glass, cardboard, foam and/or metal, light source to project drawing tools shape. Multi-functional writing device 100 can include a data processing module intended to store, retrieve, and process data.

Multi-functional writing device 100 includes a conventional pen input device for use on a paper or other writing medium, such as, for example: a ball point pen and/or a mechanical pencil lead feeder, and an active stylus, for use with a paperless medium, carried in a single housing which includes a cap portion and a barrel portion. In one embodiment of the invention, multifunctional writing device 100 also includes eraser, compass needle 110, projected ruler image 804 and 1404, projected protractor image 902 and 1504, projected set square forty-five-degree (45°) triangle image 1004 and 1604, projected set square thirty/sixty-degree (30/60°) triangle image 1104 and 1704, projected image of any shape 1204 and 1804, projected image of point or dot 1304 and 1904, and a grip in a single housing. In some embodiments, a cam arrangement is provided that selectively and alternatively allows the ball point pen and/or mechanical pencil lead feeder as well active stylus to be placed in a use position, for example, by way of a relatively simple twist of the cap portion with respect to the barrel portion. Embodiments also includes drawing tools with a housing, compartment regions, pins and an implement interchangeably mounted on one of the pins by means of a coupling mechanism which can be moved by means of a pivot bearing between inwardly pivoted position and outwardly functional position.

The drawing tools allow for various activities can perform the following example functions: writing; erasing written work; drawing straight lines; making perfect circles; making arcs; drawing accurate angles; measuring angles; etc.

FIG. 1 illustrates an example side view of a multi-functional writing device 100, according to some embodiments. Multi-functional writing device 100 can include a projected ruler image 804 and 1404. Ruler can be marked with alpha-numeric text, symbols, lines, etc. on one or both surfaces. Ruler can function as a line gauge. Ruler can be a straightedge with equally spaced markings along its length. The equally spaced lines can mark metric spacing's, in the (British) imperial and United States customary systems of measurement, etc. In one embodiments, ruler is projected from the projector pen or projector stick. In one of the instance projector stick can also act as pen clip. In another embodiment, projector stick 104 can be detachable from barrel portion 114. Accordingly, barrel portion 114 can include a means for attaching and detaching projector stick 104 (e.g. slits designed to hold projector stick 104 in place, etc.).

Protractor image 904 and 1504 can be projected through the projector pen and projector stick. Projected protractor image can be used to measure angles. (e.g. in degrees (°), radians, etc.). Radian-scale protractors measure angles in radians. For example, protractor 102 can have two (2) sets of numbers.

Projected forty-five-degree (45°) triangle image 1004, 1604 and projected thirty/sixty-degree (30/60°) triangle image 1104, 1704 can be set square instruments. Projected forty-five-degree (45°) triangle image 1004, 1604 and thirty/sixty-degree (30/60°) triangle 1104, 1704 can be used to draw a straightedge at a specified angle. Projected forty-five-degree (45°) triangle image 1004, 1604 and thirty/sixty-degree (30/60°) triangle image 1104, 1704 are provided by way of example and not of limitation as in other example embodiments, other angles for set square tools can be utilized.

Compass needle 110 can be permanently affixed to barrel portion 114 and/or detachable. A permanently affixed compass needle 110 can be retractable and/or otherwise storable in a cavity of barrel portion 114.

Grip 112 can be the portion that part of, or attachment to, barrel portion 114 that allows multi-functional writing device 100 to be moved or used by a user's hand. Barrel portion 114 can be the long barrel-housing part of the main body of multi-functional writing device 100. Grip 112 can be formed with a rubber coating and/other material (e.g. thermoplastic, etc.). The material of grip 112 can provide friction against the hand/fingers of user in order to reduce the gripping force needed to achieve a reliable grip on multi-functional writing device 100.

Writing instrument nib 116 can be either an ink-based pen nib or a mechanical-pencil nib. Accordingly, the interior portion of multi-functional writing device 100 can include the various mechanisms/devices for ink pens (e.g. ink feed, ink reservoir, fins, ink channels, etc.) and/or mechanical pencils.

In example embodiments, projected ruler image 804 and 1404, projected protractor image 902 and 1504, projected set square forty-five-degree (45°) triangle image 1004 and 1604, projected set square thirty/sixty-degree (30/60°) triangle image 1104 and 1704, projected any shape image 1204 and 1804, projected point or dot image 1304 and 1904 can be turned off when not in use. In another example, removable versions of projector stick 104 can be stored in a cavity of barrel portion. Projector stick can be formed from plastic, wood, carbon fiber, glass, cardboard, foam and/or metal, light source to project protractor drawing tools shape. Barrel portion can be formed from metallic, wood and/or plastic material(s).

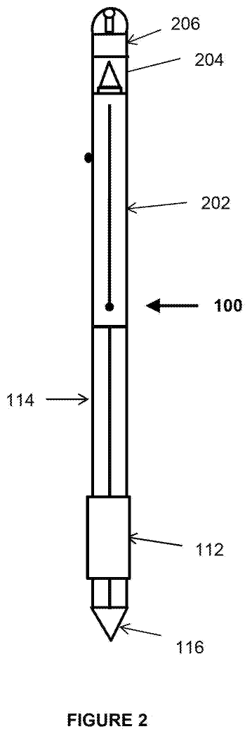

FIG. 2 illustrates another example side view of a multi-functional writing device 100, according to some embodiments. This view illustrates multi-functional writing device 100 with the various external side accessories retracted, removed, and/or otherwise not in view.

Stylus tip 206 can be a removable end portion of multi-functional writing device 100. Stylus tip 206 can be attached with friction, screw thread, etc. Stylus tip 206 can include other elements of multi-functional writing device 100 such as an eraser, etc.

Writing instrument nib 204 can be another writing instrument nib on the opposite end of writing instrument nib 116. Writing instrument nib 204 can be either an ink-based pen nib or a mechanical-pencil nib. Accordingly, the interior portion of multi-functional writing device 100 can include the various mechanisms/devices for ink pens (e.g. ink feed, ink reservoir, fins, ink channels, etc.) and/or mechanical pencils. In one example, writing instrument nib 116 can be the mechanical-pencil nib and writing instrument nib 204 can the ink-pen nib. Accordingly, the interior element of the mechanical-pencil can be in barrel portion 202.

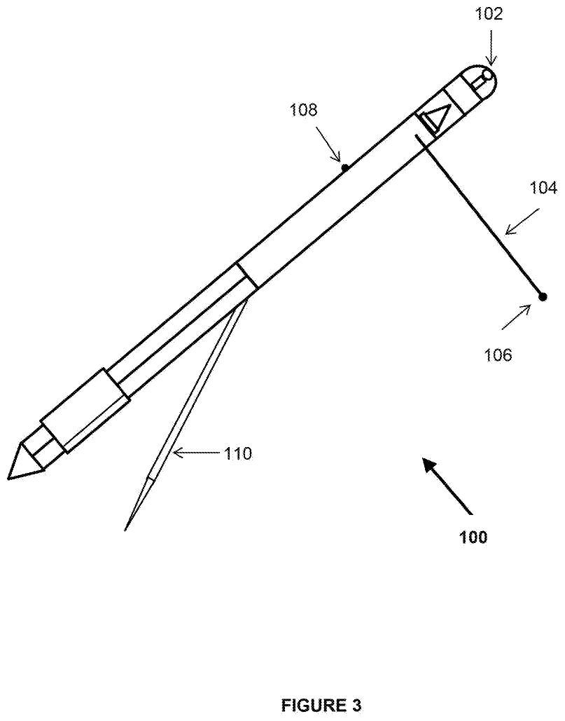

FIG. 3 illustrates an example perspective view of a multi-functional writing device 100, according to some embodiments.

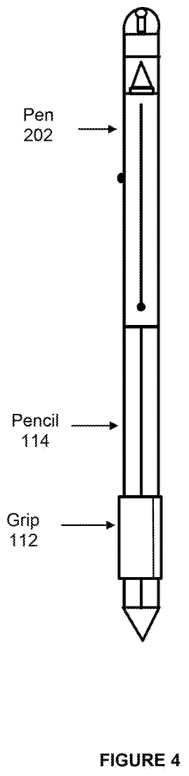

FIG. 4 illustrates another example side view of a multi-functional writing device 100, according to some embodiments.

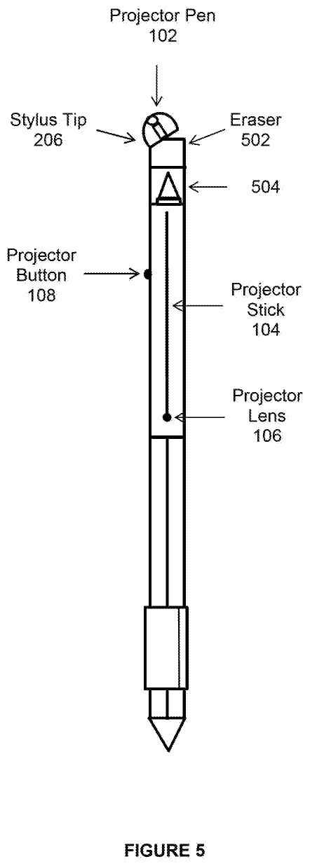

FIG. 5 illustrates another example side view of a multi-functional writing device 100, according to some embodiments. Eraser 502 can be used for removing pencil-material and/or ink writing from paper. Eraser 502 can be included in a removable cap over writing instrument nib 204. Eraser 502 can be made from made from synthetic rubber, synthetic soy-based gum, vinyl, plastic, or gum-like materials. Eraser 502 can be accessed by removal of Stylus tip 206 (e.g. as shown).

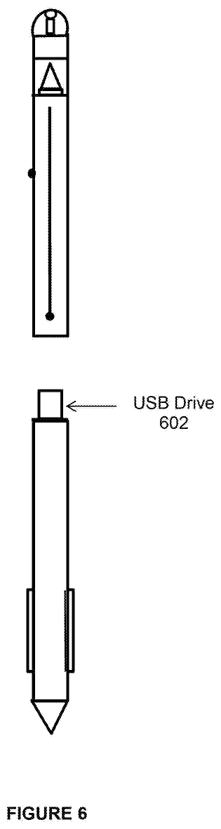

FIG. 6 illustrates another example side view of a multi-functional writing device 100 showing a USB port 602, according to some embodiments. USB port 602 can be coupled with an interior computing system of multi-functional writing device 100. The interior computing system ca n be utilized to implement the various methods provided herein (e.g. see infra).

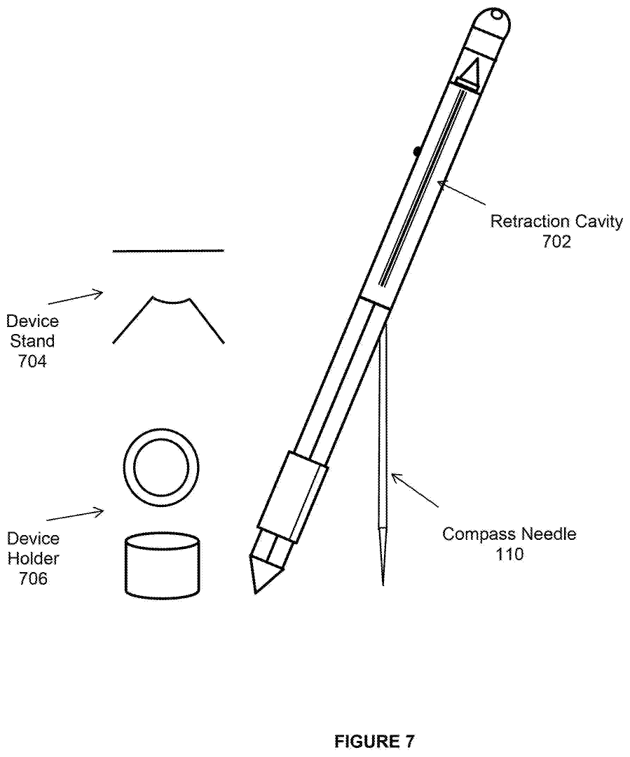

FIG. 7 illustrates another example side view of a multi-functional writing device 100 showing a compass needle 110, according to some embodiments. Retraction cavity 702 can be used for a retracted position for projector stick 104. Device stand 704 can be used to place the device in horizontal position and device holder 706 can be used to place the device in vertical position.

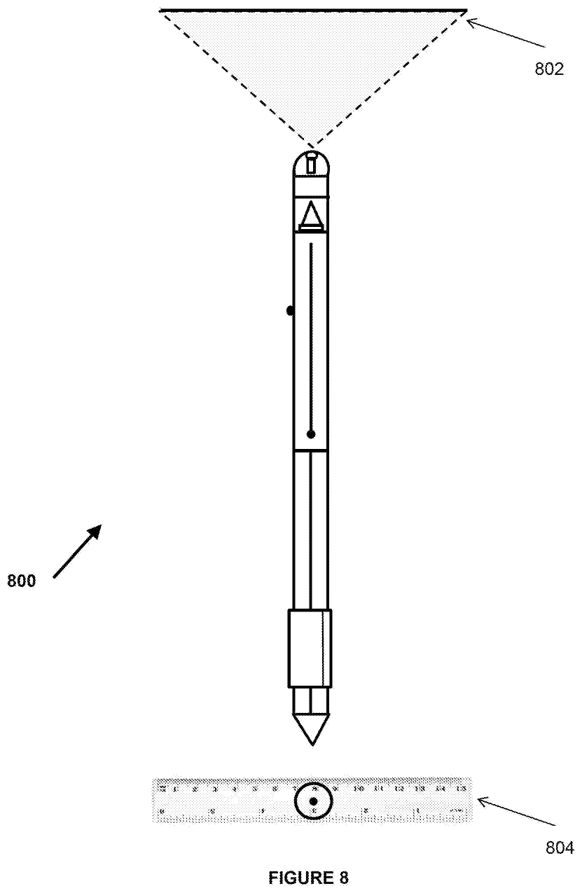

FIGS. 8 to 19 illustrates various projected technical drawing tools like ruler image (804,1404), protractor image (904,1504), forty-five-degree (45°) triangle image (1004,1604), thirty/sixty-degree (30/60°) triangle image (1104,1704), smiley image (1204,1804), light point or dot image (1304,1904). The projected image can be programmed to be of any shape. The projected shape to be projected can be selected by any of the modes like toggle switch, voice activation or rotating around the pen side of the device.

Additional Computer Systems

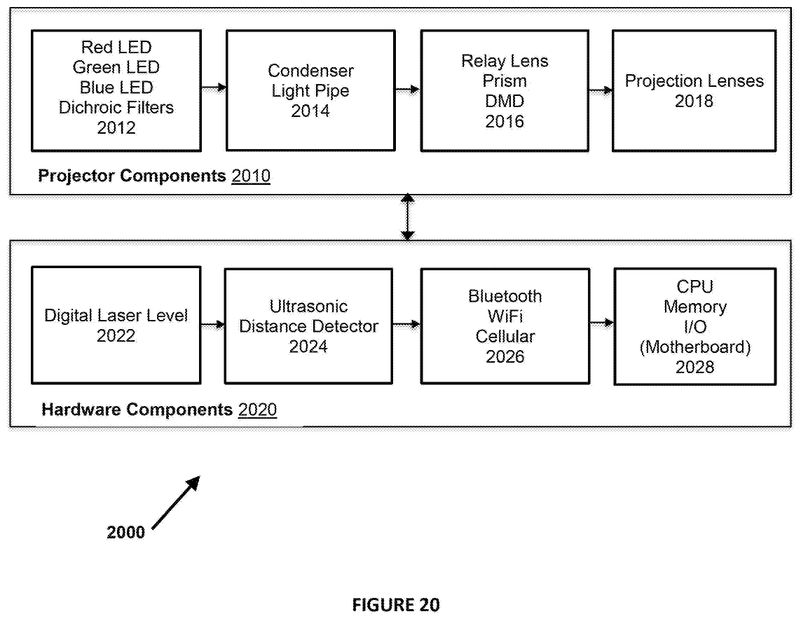

FIG. 20 depicts an exemplary computing system 2000 that can be configured to perform any one of the processes provided herein. In this context, computing system 2000 may include, for example, LED projector components, a processor, memory, storage, and I/O devices (e.g. monitor, keyboard, disk drive, Internet connection, etc.). However, computing system 2000 may include circuitry or other specialized hardware for carrying out some or all aspects of the processes. In some operational settings, computing system 2000 may be configured as a system that includes one or more units, each of which is configured to carry out some aspects of the processes either in software, hardware, or some combination thereof.

FIG. 20 depicts computing system 2000 with a number of components that may be used to perform any of the processes described herein. The system consists of projector components (e.g. pen, stick etc.) 2010 and hardware components 2020. The projector components 2010 includes red, green, blue led light source and dichroic filters 2012, collection optics condenser, light pipe which direct the light from the LED to imager 2014, relay lens, prism, digital micromirror device (DMD) 2016 accepts digital display signals to shutter the LED light and direct it to the projection optics, and projection optics lenses 2018 to project the display image on the screen and also permits functions such as, inter alia: focusing of the screen image. The projector component circuitry is used to project the technical drawing tools images to any surface. The hardware system 2020 includes a digital laser level 2022 which combines to indicate whether a surface is horizontal (level) or vertical (plumb). This is used to ensure that projected drawing tools images displayed on the surface are parallel or vertical to the reference lines like lines in ruled paper, graph paper, walls, fences etc. The ultrasonic distance detector 2024 ensures that projected technical drawing tools images are calibrated to their actual size measurement irrespective of the distance to the surface they are projected. This way the tick marks, angles and radians are accurately displayed for a given technical drawing tools. The motherboard 2028, having one or more central processing units (CPU), a memory section, and an I/O section which may have a flash memory card related to it. The I/O section can be connected to a display, a keyboard and/or other user input, a disk storage unit, and a media drive unit. Computing system 2000 can include a web browser. Moreover, it is noted that computing system 2000 can be configured to include additional systems in order to fulfill various functionalities. Computing system 2000 can communicate with other computing devices based on various computer communication protocols such a BLUETOOTH®, Wi-Fi, cellular 2026, (and/or other standards for exchanging data over short distances includes those using short-wavelength radio transmissions), USB, Ethernet, an ultrasonic local area communication protocol, etc.

Example Methods

Multifunctional writing device 100 can be utilized for various pen-computing processes. As used herein, pen computing can refer to a computer user-interface using a pen (or stylus) and tablet, rather than devices such as a keyboard, joysticks or a mouse. refers to a computer user-interface using a pen (or stylus) and tablet, rather than devices such as a keyboard, joysticks or a mouse. Multifunctional writing device 100 processes can be pointing/locator input for education purposes (e.g. test taking, mathematical problems/drawings, etc.), handwriting recognition (e.g. for student/employee verification purposes, etc.), gesture recognition, direct manipulation of educational materials, etc. As an example, smart stylus, can navigate smartphone, tablet or any other touch-screen device with ease. The digital pen function can capture digital copy of handwritten notes. The digital notes can be saved on the pen device memory or automatically to the cloud. The digital pen can use to capture class notes and organize them on a cloud-based storage. The device can also be used to do capture audio/video recordings.

In one example embodiment, multifunctional writing device 100 can be a computerized-pen. Accordingly, multifunctional writing device 100 can track user motions with the pen (e.g. using a combination of gyroscope(s), accelerometer(s), laser tracker(s), etc.). This tracking information can be stored in a computing system memory in multifunctional writing device 100. Multifunctional writing device 100 can include a networking system to access a local wireless network (e.g. BLUETOOTH® system, etc.) and communicate tracking and/or other data obtained by sensors in multifunctional writing device 100. In this way, multifunctional writing device 100 can communicatively couple with another computing system to upload data. In one example, a user can write a series of text with multifunctional writing device 100. Multifunctional writing device 100 can track this writing (e.g. as gyroscope data, accelerometer data, laser tracker data, etc.). Multifunctional writing device 100 can communicate this data to another computing system for translation to user-readable text on a computer interface. In another example embodiment, drawing and/or math tools coupled with multifunctional writing device 100 can include tracking sensors as well. Measurements and/or drawings made with the drawing and/or math tools captured by said tracking sensors and communicated to another computing system for translation to user-readable text on a computer interface. In one example, multifunctional writing device 100 can include an ultrasound system. Data from the ultrasound system can be used to for distance measurement, diagnostic imaging and/or other imaging applications.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g. embodied in a machine-readable medium).

In addition, it can be appreciated that the various operations, processes, and methods disclosed herein can be embodied in a machine-readable medium and/or a machine accessible medium compatible with a data processing system (e.g. a computer system) and can be performed in any order (e.g. including using means for achieving the various operations). Accordingly, the specification and drawings are to be regarded in an illustrative rather than a restrictive sense. In some embodiments, the machine-readable medium can be a non-transitory form of machine-readable medium.

1. A multifunctional writing instrument comprising:
a hollow body, wherein the hollow body comprises one or more cavities configured to attach with a plurality of technical drawing tools, wherein the one or more cavities are configured to attach with a projector pen and projector stick to project a plurality of technical drawing tools images on a surface, and wherein the projected technical drawing tools images are calibrated to a real-world size measurement irrespective of a projection distance to a surface projected upon;
a first writing member having a first writing tip, wherein the first writing member comprises a lead supply and a mechanical pencil system provided in a first portion of the hollow body, and wherein the first writing tip is axial with respect to the hollow body; and
a second writing member having a second writing tip, wherein the second writing member comprises an ink supply and an ink pen system provided in a second portion of the hollow body, and wherein the first portion of the hollow body is at an opposite end of the second portion of the hollow body, and wherein the second writing tip is axial with respect to the hollow body.

2. The multifunctional writing instrument of claim 1, wherein the plurality of technical drawing tools comprises a compass needle, a projector pen, and a projector stick.

3. The multifunctional writing instrument of claim 2, wherein the compass needle is stored in a compass-needle cavity.

4. The multifunctional writing instrument of claim 3, wherein the compass-needle cavity is in the first portion of the hollow body.

5. The multifunctional writing instrument of claim 4, wherein the projector stick is stored in a projector stick cavity.

6. The multifunctional writing instrument of claim 5, wherein the projector stick cavity is in the second portion of the hollow body.

7. The multifunctional writing instrument of claim 6, wherein the projector pen is in the second portion of the hollow body.

8. The multifunctional writing instrument of claim 7, wherein the projector pen or projector stick is switched on or off using a power button.

9. The multifunctional writing instrument of claim 8, wherein the projector pen or the projected technical drawing tools image is selected using a voice activation system or rotating a barrel on a pen side of the multifunctional writing instrument.

10. The multifunctional writing instrument of claim 9, wherein the projector pen or projector stick is used to project a plurality of the projected technical drawing tools image, and wherein the wherein the projected technical drawing tools image comprises a ruler image, a protractor image, set square thirty/sixty-degree (30/60°) triangle image, a set square forty-five-degree (45°) triangle image.

11. The multifunctional writing instrument of claim 10, wherein the plurality of technical drawing tools images further comprises an ellipsograph image, a T-square image or an opisometer image.

12. The multifunctional writing instrument of claim 11, wherein the plurality of technical drawing tools images are programmed to be a specified shape.

13. The multifunctional writing instrument of claim 12, wherein the plurality of technical drawing tools images projected to the surface are leveled using a digital laser level.

14. The multifunctional writing instrument of claim 13, wherein the plurality of technical drawing tools images projected are calibrated to their actual size measurement irrespective of a distance to a surface using an ultrasonic distance sensor.

15. The multifunctional writing instrument of claim 14, wherein the hollow body comprises one or more cavities configured to attach with a compass needle and a projector stick.

16. The multifunctional writing instrument of claim 15, wherein the tip of the second portion of the hollow body comprises a stylus cover over a tip of the ink pen system and the projector pen.

17. The multifunctional writing instrument of claim 16, wherein the stylus cover comprises an eraser.

18. The multifunctional writing instrument of claim 17, wherein the multifunctional writing instrument comprises projector comprises a red LED, a green LED, a blue LED, a condenser, a light pipe, a relay lens, a prism, a Digital micromirror device (DMD), and a projection lens.

19. The multifunctional writing instrument of claim 18, wherein the multifunctional writing instrument comprises the digital laser level, the ultrasonic distance detector, a BLUETOOTH system, WI-FI system, and Cellular network transceiver system.

20. The multifunctional writing instrument of claim 19, wherein the multifunctional writing instrument comprises a computer processor, a computer memory an input port and an output ports.
